(19) United States
(12) Patent Application Publication
(10) Pub. No.: US 2003/0162023 A1
(43) Pub. Date: Aug. 28, 2003

(54) Panel having a dry polymer reinforced pet substrate

(75) Inventor: Frederick L. Hjortsberg, Perrysburg, OH (US)

Correspondence Address: BROOKS & KUSHMAN P.C. / LEAR CORPORATION, 1000 TOWN CENTER TWENTY-SECOND FLOOR, SOUTHFIELD, MI, 48075, US

(73) Assignee: LEAR CORPORATION, Southfield, MI

(21) Appl. No.: 10/083,826

(22) Filed: Feb. 27, 2002

(51) Int. Cl. B32B 3/00; B32B 5/02; B32B 9/00; B01D 50/00; B01D 53/34; D04H 1/00; D04H 3/00; D04H 5/00; D04H 13/00; B32B 9/04; B32B 27/00; B32B 27/40

(52) U.S. Cl. 428/411.1; 428/423.7; 442/327; 442/59

(57) ABSTRACT

A panel comprising a coverstock layer, an adhesive layer, and at least one substrate layer comprising a polyester mat having dry acrylic polystyrene copolymer. The panel may also include at least one fiber layer also having dry acrylic polystyrene copolymer.

### BACKGROUND OF THE INVENTION

1. Field of the Invention

This invention relates to an automotive interior panel and, in particular, a panel made out of a dry acrylic polystyrene copolymer reinforced PET substrate. The substrate layer may be covered with an adhesive layer and a coverstock layer. Further, the panel may have multiple substrate layers having dry acrylic polystyrene copolymer.

2. Background Art

Automotive panels, such as vehicle headliners, are typically placed along the ceiling of a vehicle. Headliners include a plurality of layers of distinct materials designed to, in combination, absorb sound, have rigidity in strength, and also to provide a pleasing visual appearance. Typically, a number of layers of different materials are used to achieve the various desired properties.

Current panels, such as headliners, are manufactured out of layers of polyethylene terapthalate (PET) and fiberglass, 100% fiberglass, polyurethane foams, cardboard, or resinated cotton fibers. However, the fiberglass panels are not 100% recyclable and there are also perceived handling issues. Some of the other types of substrates contain costly resin systems that are not operator friendly.

### SUMMARY OF THE INVENTION

The present invention overcomes the problems encountered in the prior art by providing a panel comprising at least one substrate layer comprising a polyester mat having dry acrylic polystyrene copolymer.

In another embodiment, a panel comprising a fiber mat having dry acrylic polystyrene copolymer, and a polyester mat having approximately 30% dry acrylic polystyrene copolymer.

The embodiment may also be covered with an adhesive layer and a coverstock layer. Further, the panel may have multiple fiber layers and substrate layers.

The PET substrate of the present invention offers 100% recyclability, improved user-friendly handling due to lack of fiberglass content, no post processing odor, greater moldability and design freedom over the material over urethane systems, improved acoustic performance over urethane systems, an ease of flexibility to achieve the desired performance characteristics of flexural modules, and offset yield loading.

These and other advantages of the present invention will become apparent to one of ordinary skill in the art in light of the following description and attached drawings.

### BRIEF DESCRIPTION OF THE DRAWINGS

FIG. 1 shows a first embodiment panel according to the present invention; and

FIG. 2 shows a second embodiment panel according to the present invention;

FIG. 3 shows a third embodiment panel according to the present invention; and

FIG. 4 shows the method steps for forming a panel according to the present invention.

### DETAILED DESCRIPTION OF THE PREFERRED EMBODIMENT(S)

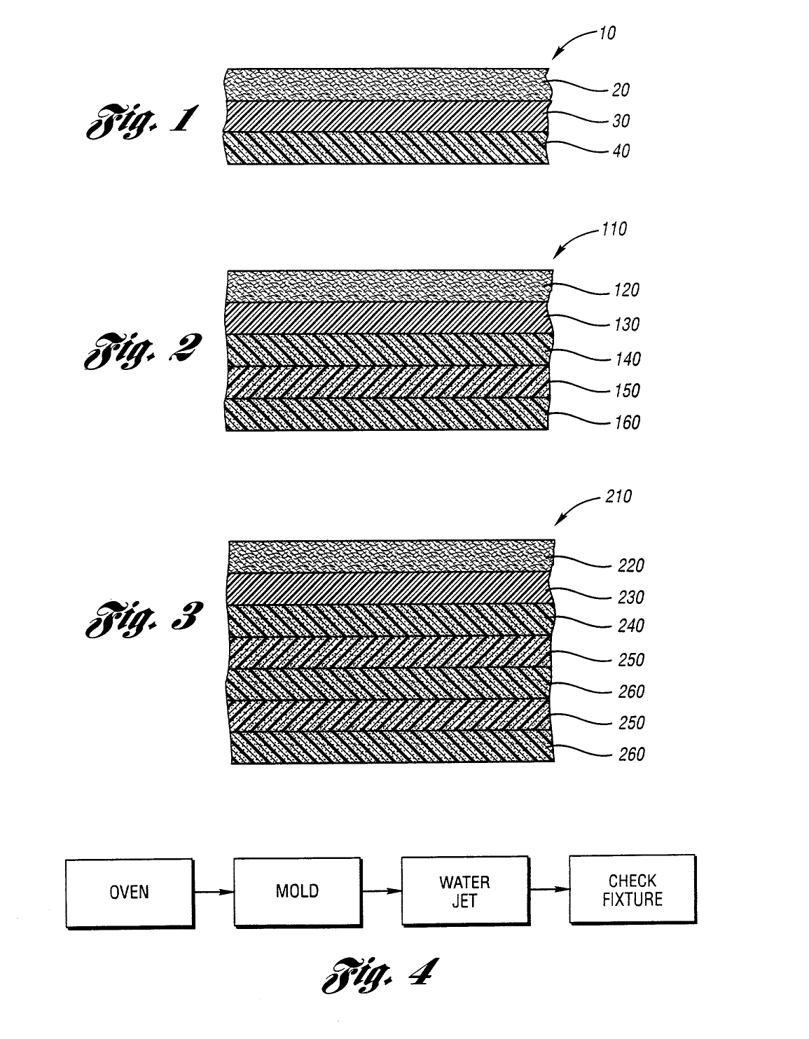

A panel 10 of the present invention is shown in FIG. 1. An outer coverstock 20 covers the panel when, for example, the panel is made into a headliner. The coverstock is preferably a 5 mm thick flamebacked polyether foam provided by Milliken Chemical of South Carolina having Part No. WC1147.

A spray adhesive 30 secures the coverstock 20 to a substrate 40. The adhesive preferably is a solvent-based chloroprene family contact adhesive supplied by Probst of Mexico having Part No. 4098. Preferably, the adhesive is robotically applied. Another option is a water-based contact adhesive supplied by Probst.

Substrate layer 40 is a reinforced polyester mat having a weight of approximately 400, 900, 1000, or 1200 grams per square meter. Preferably, the polyester mat is made out of PET. The matrix fiber is preferably 4 denier and the binder fiber is preferably bi-component 4 denier having a blend ratio of 70% +/−1% by weight. Preferably, the matrix and binder fibers are also made out of PET. The thickness of the polyester mat is approximately 15 mm, +/−10% crystalline formation. The thickness may also range from 25-36 mm in thickness. The fiber melt temperature is approximately 250° C. The fiber core melt temperature is also approximately 250° C. The sheet weight is less than 50% of the total fiber weight and the sheet melt temperature is 160° C. The polyester mat layer is has dry acrylic polystyrene copolymer by weight. Preferably, the polyester mat layer has 10% to 80% content of a dry acrylic polystyrene copolymer by weight. Even more preferable is a polyester mat layer having 30% content of a dry acrylic polystyrene copolymer by weight. The amount of dry acrylic polystyrene copolymer can be veined to vary different mechanical properties such as strength and flexibility. The dry acrylic polystyrene copolymer is preferably Vinnex 3101A available from Wacker Polymer Systems of Germany. The dry acrylic polystyrene copolymer is uniformly applied via needled application, powder scattering technology, or electrostatic deposition onto the outer fiber layers. The dry acrylic polystyrene copolymer is to be B-staged for subsequent re-melt processing.

In a second embodiment, shown in FIG. 2, the headliner 110 comprises five layers for added strength and durability. Coverstock layer 120 is similar to layer 20 of the first embodiment; adhesive layer 130 is similar to adhesive layer 30 of the first embodiment, and substrate layer 140 is similar to substrate layer 40 of the first embodiment. The second embodiment comprises additional substrate layers 150 and 160 which are the same as substrate layer 40.

A third embodiment of the present invention is shown in FIG. 3. This embodiment comprises a top layer of coverstock 220, a layer of spray adhesive 230, and a polyester substrate layer 250 similar to those described in the first two embodiments. This embodiment, however, comprises a fiber mat layer 240 between the spray adhesive layer 230 and the substrate layer 250. The fibers in the fiber mat layer may be sisal, cotton, hemp, jute, or other natural fibers. The fiber mat layer 240 preferably has a 100 gram per meter squared apertured construction with a dry tensile MD (machine direction) of 600 newtons per square meter and a dry tensile CD (cross machine direction) of 450 newtons per square meter resulting in MD to CD ratio of 1.5. The dry elongation CD is approximately 3%. The wet MD tensile is approximately 150 newtons per meter. The fiber mat layer 240 has a thickness of approximately 850 microns.

The fibers in the fiber mat layer have approximately a dry acrylic polystyrene copolymer added using one of the methods discussed above. Preferably, the fiber mat layer has 10% to 80% dry acrylic polystyrene copolymer added. Even more preferable is a fiber mat layer having approximately 30% dry acrylic polystyrene copolymer added. Preferably, the dry acrylic polystyrene copolymer is Vinnex 3101A as discussed above.

A polyester substrate layer 250, similar to the substrate layer 40 discussed above, is disposed under the fiber mat layer 240. Additionally, other substrate and fiber mat layers may be stacked to increase the strength of the final product. Preferably, two substrate layers 260 and 280 sandwich another fiber mat 270 as shown in FIG. 3.

FIG. 4 schematically shows a method for forming any one of the panels of the present invention. Several layers are assembled together but have not yet been bonded together. The layers are passed into an oven which heats the layers to a sufficient temperature to activate the adhesive layer. In the oven, layers are bonded together. From the oven, the panel is then moved into a mold where it is molded to its desired shape. The shaped panel may then be moved to a waterjet cutting station which cuts the shaped panel to the desired final shape for the vehicle. From there, the cut panel may be moved to a fixture which then checks the final shape to ensure that it is as desired.

The use of the oven eliminates the wet binder process which has been utilized in the past to form the several panel layers into a panel. The elimination of the wet binder layer also eliminates pollutants into the air that are formed when wet binders are utilized.

Although described for use in as a panel, the material herein disclosed can be also used for other automotive applications such as headliners, door panels and trim panels. In certain applications, the panel may not need to have a coverstock and adhesive layer and, may comprise only of dry acrylic polystyrene copolymer reinforced layers. Further, the material disclosed herein may be used for other non-automotive applications.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A panel comprising:
at least one substrate layer having a polyester mat comprising acrylic polystyrene copolymer.

2. The panel of claim 1 further comprising an outer coverstock layer and an adhesive layer for adhering the coverstock layer to the substrate.

3. The panel of claim 1 further comprising two additional substrate layers having polyester mats modified to have acrylic polystyrene copolymer.

4. The panel of claim 1 wherein the panel is a headliner.

5. The panel of claim 1 wherein the substrate layer comprises 10% to 80% dry acrylic polystyrene copolymer by weight.

6. The panel of claim 1 wherein the substrate layer comprises 30% dry acrylic polystyrene copolymer by weight.

7. The panel of claim 1 further comprising a fiber layer comprising dry acrylic polystyrene copolymer.

8. The panel of claim 7 when the fiber layer comprises 10% to 80% dry acrylic polystyrene copolymer by weight.

9. The panel of claim 7 wherein the fiber layer comprising 30% dry acrylic polystyrene copolymer by weight.

10. A multi-layer panel comprising:
at least one fiber layer having dry acrylic polystyrene copolymer; and
at least one substrate layer having a polyester mat comprising dry acrylic polystyrene copolymer.

11. The multi-layer panel of claim 10 further comprising an outer coverstock layer and an adhesive layer for adhering the coverstock layer to the fiber layer.

12. The multi-layer panel of claim 10 wherein the substrate layer comprising 10% to 80% dry acrylic polystyrene copolymer by weight.

13. The multi-layer panel of claim 10 wherein the panel is a headliner.

14. A headliner comprising:
an outer coverstock layer;
an adhesive layer;
a fiber layer comprising dry acrylic polystyrene copolymer; and
a substrate layer having a polyester mat comprising dry acrylic polystyrene copolymer.

15. The headliner of claim 14 wherein the substrate layer comprises 10% to 80% of dry acrylic polystyrene copolymer by weight.

16. The headliner of claim 14 wherein the fiber layer comprises 10% to 80% dry acrylic polystyrene copolymer by weight.

17. The headliner of claim 14 wherein the fiber layer comprises sisal fibers..

18. The headline of claim 14 wherein both the substrate layer and the fiber layer comprises 30% of dry acrylic polystyrene copolymer by weight.
